(19) United States
(12) Patent Application Publication
(10) Pub. No.: US 2016/0371049 A1
(43) Pub. Date: Dec. 22, 2016

(54) CONTROL SYSTEM AND METHOD FOR AN LED DISPLAY APPARATUS

(71) Applicant: SIGNKLOUD, INC., Santa Clara, CA (US)

(72) Inventors: Song SHANG, Guangdong (CN); Charles Thiam-Beng TAN, Redwood City, CA (US); Mark MAH, Saratoga, CA (US)

(21) Appl. No.: 15/252,087

(22) Filed: Aug. 30, 2016

Related U.S. Application Data
(63) Continuation of application No. PCT/CN2015/070434, filed on Jan. 9, 2015.

(30) Foreign Application Priority Data
Jul. 29, 2014 (CN) 201420422489.7
Sep. 9, 2014 (CN) 201420516188.0
Nov. 26, 2014 (CN) 201420721835.1
Jan. 9, 2015 (CN) PCT/CN2015/070434

(51) Int. Cl. G06F 3/14; G09G 3/20; G06Q 30/06; G09G 3/32

(52) U.S. Cl. CPC G06F 3/1454; G09G 3/32; G09G 3/2092; G06Q 30/0613; G09G 2370/16

(57) ABSTRACT

A control system and method of an LED display apparatus are disclosed in embodiments of the present disclosure. The control system comprises an LED display apparatus and an editing terminal. The LED display apparatus comprises a master control unit and a wireless communication module. The wireless communication module is connected with the master control unit and is configured to be communicatively connected with the editing terminal, and the master control unit is configured to process a control signal of the LED display apparatus and drive displaying of LED lamps. The editing terminal is connected with the LED display apparatus through wireless communication and is configured to edit information to be displayed by the LED display apparatus and send the information to be displayed that has been edited to the LED display apparatus for displaying.

### INCORPORATION BY REFERENCE

This application is a continuation of International Application No. PCT/CN2015/070434, filed Jan. 9, 2015, which is based upon and claims priority to Chinese Patent Application 201420422489.7, filed Jul. 29, 2014, and claims priority to Chinese Patent Application 201420516188.0, filed Sep. 9, 2014, and to Chinese Patent Application 201420721835.1 filed on Nov. 26, 2014, the entire contents of all of which are incorporated herein by reference.

### FIELD OF THE INVENTION

The present disclosure relates to the technical field of LED electronic display screen, and more particularly, to a control system and method for an LED display apparatus.

### BACKGROUND OF THE INVENTION

Nowadays, the light emitting diode (LED) electronic display screen is a kind of commonly used display apparatus, and the existing LED display screen usually adopts a box structure and is disposed on an indoor or outdoor wall.

Firstly, the LED electronic display screen of the prior art needs to be connected with a controller (generally a computer) in a wired way during the use, the computer inputs contents to be displayed into a storing unit within the LED display screen, and the LED electronic display screen reads information from the storing unit and displays the related contents correspondingly. When the displayed contents need to be replaced, the display screen has to be reconnected to the computer via a data line, so it is very inconvenient in use. Because structures such as the storing unit are needed in the LED display screen, the box structure is thick and cumbersome as a whole. Secondly, the PCB board of the display screen, the related electronic devices and the box of the traditional LED display screen are connected together through a plastic panel, so the heat generated by the electronic devices can only be dissipate by virtue of air convection, and this undoubtedly and remarkably reduces the efficiency of thermal conductivity and puts the display screen in a unstable thermal condition.

Moreover, the LED display screen of the prior art is usually used independently and the displayed information thereof is only connected with one computer, which makes it extremely inconvenient to control the LED display screen and to edit the displayed contents thereof.

### SUMMARY OF THE INVENTION

In view of this, the present disclosure provides a control system and a method for an LED display apparatus. The control system comprises an LED display apparatus and an editing terminal. The LED display apparatus comprises a master control unit and a wireless communication module; wherein the wireless communication module is connected with the master control unit and is configured to be communicatively connected with the editing terminal, and the master control unit is configured to process a control signal of the LED display apparatus and drive displaying of LED lamps. The editing terminal is communicatively connected with the LED display apparatus and is configured to edit information to be displayed by the LED display apparatus and send the information to be displayed that has been edited to the LED display apparatus for displaying.

According to a preferred embodiment of the present disclosure, the control system further comprises a cloud server, wherein the cloud server is connected to the wireless communication module of the LED display apparatus and the editing terminal via a network, the editing terminal stores the information to be displayed into the cloud server, and the cloud server stores and processes the information to be displayed so that the LED display apparatus downloads the information to be displayed from the cloud server and displays the information to be displayed. According to a preferred embodiment of the present disclosure, the editing terminal is one of a mobile phone, a portable notebook computer and a desktop computer.

According to a preferred embodiment of the present disclosure, the editing terminal has an application loaded therein, and is connected to the cloud server via the application so as to edit the information displayed on the LED display apparatus.

According to a preferred embodiment of the present disclosure, the cloud server has an information exchange community for an owner of the LED display apparatus and an editor of the contents displayed by the LED display apparatus to exchange information.

According to a preferred embodiment of the present disclosure, the LED display apparatus further comprises an online upgrade module, and the online upgrade module is connected to the master control unit and is configured to download the latest version of operation system from the cloud server and upgrade the system via the wireless communication module.

According to a preferred embodiment of the present disclosure, the LED display apparatus further comprises a metal plate and a mounting plate, a plurality of LED lamps are arrayed on one side of the mounting plate and the master control unit is disposed on the other side of the mounting plate, the metal plate is connected with the side of the mounting plate where the master control unit is disposed so as to dissipate heat from the mounting plate, the metal plate is spaced apart from the mounting plate via a fixing part, and the fixing part comprises a body, a first fixing portion and a convex portion; and wherein the body has two opposite sides, the first fixing portion protrudes from the first side and is connected to the mounting plate, the convex portion protrudes from the second side and is connected to the metal plate, and an insulative thermally conductive adhesive is disposed between the metal plate and the mounting plate.

To solve the aforesaid technical problems, the present disclosure further provides a communication method based on an LED display apparatus, and the communication method comprises the following steps of: receiving an information displaying desire from an information displaying demand side by a cloud service platform; transmitting the information displaying desire to a displayed information editing side; receiving and storing displayed information contents that have been edited by the displayed information editing side; and transmitting the displayed information that has been edited to the LED display apparatus for displaying.

To solve the aforesaid technical problems, the present disclosure further provides a communication method based on an LED display apparatus, and the communication method comprises the following steps of: transmitting an information displaying desire to a cloud service platform by an information displaying demand side according to a displaying demand of the LED display apparatus; transmitting the information displaying desire to a displayed information editing side by the cloud service platform; editing contents of the displayed information by the displayed information editing side on the cloud service platform according to the demand of the information displaying demand side, and storing the displayed information contents that have been edited into the cloud service platform; and transmitting the displayed information that has been edited to the LED display apparatus by the cloud service platform for displaying.

According to a preferred embodiment of the present disclosure, the communication method further comprises the following step before the step of transmitting the displayed information that has been edited to the LED display apparatus by the cloud service platform for displaying: simulating the displayed information contents that have been edited on the LED display apparatus.

According to a preferred embodiment of the present disclosure, the information displaying demand side is one of an owner of the LED display apparatus and a third party other than the owner of the LED display apparatus.

To solve the aforesaid technical problems, the present disclosure additionally provides a communication system based on an LED display apparatus. The communication system comprises an LED display apparatus, a cloud service platform and a displayed information editing side. The cloud service platform is communicatively connected with the LED display apparatus; the information displaying demand side transmits an information displaying desire to the cloud service platform according to a displaying demand of the LED display apparatus; the cloud service platform transmits the information displaying desire to the displayed information editing side, the displayed information editing side edits contents of the displayed information according to the demand of the information displaying demands side and stores the displayed information contents that have been edited into the cloud service platform, and the cloud service platform transmits the displayed information that has been edited to the LED display apparatus for displaying.

According to a preferred embodiment of the present disclosure, the cloud service platform comprises a simulation module configured to simulate the displayed information contents that have been edited on the LED display apparatus before the displayed information contents that have been edited are transmitted to the LED display apparatus for displaying.

According to a preferred embodiment of the present disclosure, the information displaying demand side is one of an owner of the LED display apparatus and a third party other than the owner of the LED display apparatus.

The present disclosure provides a trading method based on an LED display apparatus. The trading method comprises the following steps of: purchasing an LED display apparatus and obtaining the ownership of the LED display apparatus by a user; transmitting a desire to display information on the LED display apparatus to a cloud service platform by a demand side that desires to display information on the LED display apparatus; finding a displayed information editor by the cloud service platform according to the information displaying desire, wherein the displayed information editor edits the displayed information required by the user of the LED display apparatus; and transmitting, by the cloud service platform, the displayed information that has been edited by the displayed information editor to the LED display apparatus for displaying. According to a preferred embodiment of the present disclosure, the trading method further comprises the following step before the step of transmitting, by the cloud service platform, the displayed information that has been edited by the displayed information editor to the LED display apparatus for displaying: simulating the displayed information contents that have been edited on the LED display apparatus.

According to a preferred embodiment of the present disclosure, the owner of the LED display apparatus can play his/her own displayed contents or contents required by a third party on his/her LED display apparatus.

The control system and method for the LED display apparatus according to the embodiments of the present disclosure can achieve effective communication between users of the LED display apparatus as well as between a user and a service provider, and the full working process of the LED display apparatus is edited and controlled by the cloud server and cloud netware, so the using convenience of the LED display apparatus is remarkably improved and the application of the LED display apparatus is widened. Moreover, resources of a displayed contents provider, a cloud screen owner and a designer are effectively integrated together by the trading method through the cloud service platform so that the aforesaid all parties can exchange information through the cloud service platform and two “triple-win” business modes are achieved between the cloud screen owner, the cloud service platform and the designer as well as between the cloud screen owners, the cloud service platform and the displayed contents provider respectively. This has a very high market operation value, the cloud screen may be the LED display apparatus, and the designer may be the displayed information editor.

### BRIEF DESCRIPTION OF THE DRAWINGS

FIG. 1 is an overall schematic structural view of a preferred embodiment of an LED display apparatus according to the present disclosure;

FIG. 2 is a schematic view illustrating part of the internal structure of a preferred embodiment of the LED display apparatus in the embodiment of FIG. 1;

FIG. 3 is a schematic structural view of a first embodiment of a fixing part between a metal plate and a mounting plate of the LED display apparatus in the embodiment of FIG. 1;

FIG. 4 is a schematic structural view of a second embodiment of the fixing part in the embodiment of FIG. 1;

FIG. 5 is a schematic structural view of a third embodiment of the fixing part in the embodiment of FIG. 1;

FIG. 6 is a schematic structural view of a second fixing portion of a fourth embodiment of the fixing part in the embodiment of FIG. 1;

FIG. 7 is a schematic structural view of the fourth embodiment of the fixing part in the embodiment of FIG. 1;

FIG. 8 is a schematic structural view illustrating application of the fourth embodiment of the fixing part to an embodiment of the LED display apparatus;

FIG. 9 is a schematic structural view illustrating application of the fourth embodiment of the fixing part to another embodiment of the LED display apparatus;

FIG. 10 is a schematic structural view of an LED display apparatus in a backlight direction according to a preferred embodiment of the present disclosure;

FIG. 11 is a schematic structural view of an LED display apparatus in a backlight direction according to another preferred embodiment of the present disclosure;

FIG. 12 is a schematic structural view of an LED display apparatus in a light-emitting direction according to a preferred embodiment of the present disclosure;

FIG. 13 is a schematic structural view of an LED display apparatus in a light-emitting direction according to another preferred embodiment of the present disclosure;

FIG. 14 is a schematic structural view of a preferred embodiment of a fixing support of an LED display apparatus according to the present disclosure;

FIG. 15 is a schematic structural view of another preferred embodiment of the fixing support of the LED display apparatus according to the present disclosure;

FIG. 16 is schematic view illustrating in header distribution of a power supplying structure of the LED display apparatus according to the present disclosure;

FIG. 17 is a structural block diagram of a preferred embodiment of the control system of the LED display apparatus according to the present disclosure;

FIG. 18 is a structural block diagram of another preferred embodiment of the control system of the LED display apparatus according to the present disclosure;

FIG. 19 is a structural block diagram of a further preferred embodiment of the control system of the LED display apparatus according to the present disclosure;

FIG. 20 is a schematic flowchart diagram of a preferred embodiment of a communication method based on an LED display apparatus according to the present disclosure;

FIG. 21 is a structural block diagram of a preferred embodiment of a communication system according to the present disclosure;

FIG. 22 is a structural block diagram of another preferred embodiment of the communication system according to the present disclosure;

FIG. 23 is a schematic flowchart diagram of a preferred embodiment of a trading method based on an LED display apparatus according to the present disclosure;

FIG. 24 is an information flowchart diagram between trading parties of an embodiment of the trading method in the embodiment of FIG. 21; and

FIG. 25 is an information flowchart diagram between trading parties of another embodiment of the trading method in the embodiment of FIG. 21.

FIG. 26 is a schematic view illustrating part of the internal structure of another preferred embodiment of the LED display apparatus in the embodiment of FIG. 1.

### DETAILED DESCRIPTION OF THE INVENTION

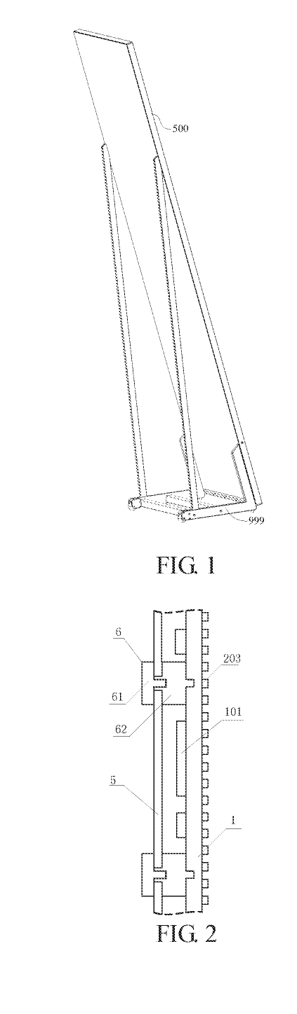

Referring to FIG. 1, FIG. 2 and FIG. 26 together, FIG. 1 is an overall schematic structural view of a preferred embodiment of an LED display apparatus according to the present disclosure; and FIG. 2 is a schematic view illustrating part of the internal structure of a preferred embodiment of the LED display apparatus in the embodiment of FIG. 1; FIG. 26 is a schematic view illustrating part of the internal structure of another preferred embodiment of the LED display apparatus in the embodiment of FIG. 1. The LED display apparatus comprises a mounting plate 1, a metal plate 5, a master control unit and a wireless communication module (not shown).

Specifically, a plurality of LED lamps are arrayed on one side of the mounting plate 1 and the master control unit is disposed on the other side of the mounting plate 1, the master control unit is a plurality of components 101, and the metal plate 5 is connected with the side of the mounting plate 1 where the master control unit is disposed so as to dissipate heat from the mounting plate 1. The wireless communication module (not shown) is connected with the master control unit and is configured to be communicatively connected with an external communication equipment, and the master control unit has an operation system embedded therein so as to process a control signal of the LED display apparatus and drive the LED lamps to display corresponding contents. The wireless communication module is preferably a wifi communication module. Of course, the wireless communication module is not limited to the wifi communication module, and it may also be a Bluetooth module or the like, and this will not be enumerated herein.

In FIG. 26, the components 101 tightly arranged with the metal plate 5, can make the components 101 a better cooling effect.

Preferably, the LED display apparatus further comprises a support 999 for supporting. The support 999 may also be provided with rollers to facilitate handling of the LED display apparatus. The metal plate 5 is spaced apart from the mounting plate 1 via a fixing part. Referring to FIG. 3 to FIG. 13 together, FIG. 3 to FIG. 13 are schematic structural views of a plurality of embodiments of the fixing part and the LED display 10 apparatus.

As shown in FIG. 3, one embodiment of the present disclosure provides a fixing part that comprises a body 102, a first fixing portion 103 and a convex portion 101. As shown in FIG. 3, the body has two opposite sides, the first fixing portion protrudes from the first side, and the convex portion protrudes from the second side. Preferably, the body is thicker than the convex portion so that the distance between two external apparatuses is larger than the thickness of an apparatus disposed at the convex portion, or the distance between the two external apparatuses can be guaranteed to some extent. For example, the two external apparatuses are respectively an external LED display apparatus and an external heat dissipating structure (e.g., a heat dissipating plate), and the distance there between is just the thickness of the body. To make the production and installation convenient, the body, the first fixing portion and the convex portion are preferably disposed integrally.

To better fix the fixing part via the first fixing portion, the first fixing portion is preferably a plug portion, a thread jointing portion or a clamping portion. As shown in FIG. 3, the first fixing portion 103 is a plug portion with a sharp point; as shown in FIG. 4, the first fixing portion 103 is a plug portion with a blunt end; and as shown in FIG. 5, the first fixing portion 103 is a thread jointing portion. As shown in FIG. 4, the convex portion is preferably provided with a first fixing place 104. Preferably, the fixing part further comprises a second fixing portion, the convex portion is provided with a first fixing place, and the second fixing portion is fixed within the first fixing place. For example, as shown in FIG. 7, the second fixing portion is fixed on the convex portion through the first fixing place. In this way, the second fixing portion is fixed with the convex portion, and the position of an external structure disposed at the convex portion can be maintained.

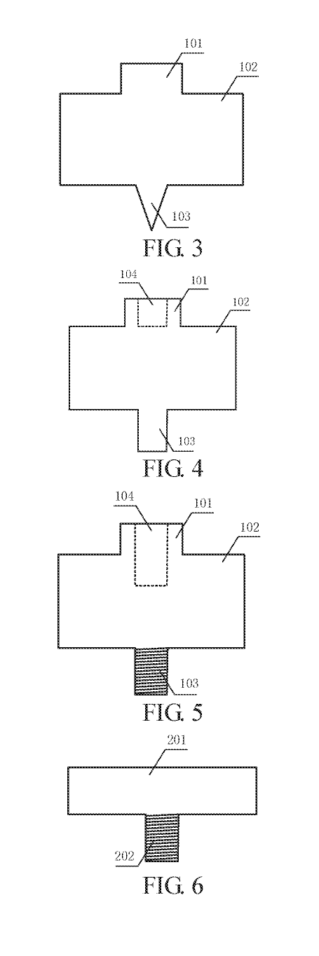

As shown in FIG. 6, the second fixing portion is provided with a mounting end 201 and a bonding end 202. For example, as shown in FIG. 6, the bonding end 202 has a threaded structure, and the second fixing portion is fixed within the first fixing place through screw threads. The mounting end 201 is integrally formed with the bonding end 202. Preferably, the cross-sectional area of the part of the body that adjoins the convex portion is larger than the cross-sectional area of the convex portion, and the cross-sectional area of the part of the second fixing portion that adjoins the convex portion is also larger than the cross-sectional area of the convex portion so that the second fixing portion and the body can together clamp an external structure disposed at the convex portion. The body, the convex portion, and the second fixing portion are respectively a cylinder, a cuboid and a hexagonal prism, etc. Preferably, the diameter of the body is larger than the diameter of the convex portion, and the diameter of the second fixing portion is larger than the diameter of the convex portion. For example, the diameter of the body and the diameter of the second fixing portion are 4 mm to 12 mm larger than the diameter of the convex portion respectively. Preferably, the body is provided with a second fixing place that is in communication with the first fixing place, and the second fixing portion is fixed within the first fixing place and the second fixing place. Preferably, the second fixing portion is fixed within the first fixing place and the second fixing place through screw threads. Preferably, as shown in FIG. 5, the first fixing place and the second fixing place are integrally disposed as the first fixing place 104.

In connection with the fixing part described in any of the aforesaid embodiments, another embodiment of the present disclosure is as follows: an LED display apparatus is provided that comprises a mounting plate, at least one metal plate, and a plurality of fixing parts described in any of the aforesaid embodiments. For example, as shown in FIG. 8, an LED display apparatus comprises a mounting plate 500, at least one metal plate 300, and a plurality of fixing parts 100 described in any of the aforesaid embodiments. The mounting plate is provided with a plurality of third fixing places 501, each of the plurality of third fixing places is provided with an opening area at least at the second side, and the first fixing portion of the fixing part is fixed within the third fixing place through the opening area. A mounting space 400 is formed between the second side of the mounting plate 500 and the at least one metal plate 300, the metal plate 300 is provided with a plurality of fourth fixing places 301, each of the plurality of fourth fixing places corresponds to one of the third fixing places, and the convex portion is at least partially disposed within the fourth fixing place. Preferably, each of the fourth fixing places is a through place, and the convex portion is completely disposed within the fourth fixing place; and the height of the convex portion is equal to the thickness of the metal plate. As shown in FIG. 9, the first side of the mounting plate 500 is provided 15 with a plurality of LED lamps 504, and the second side thereof is provided with a plurality of components including, e.g., a plurality of resistors 502, a plurality of capacitors 505, and a plurality of chips 503, etc.

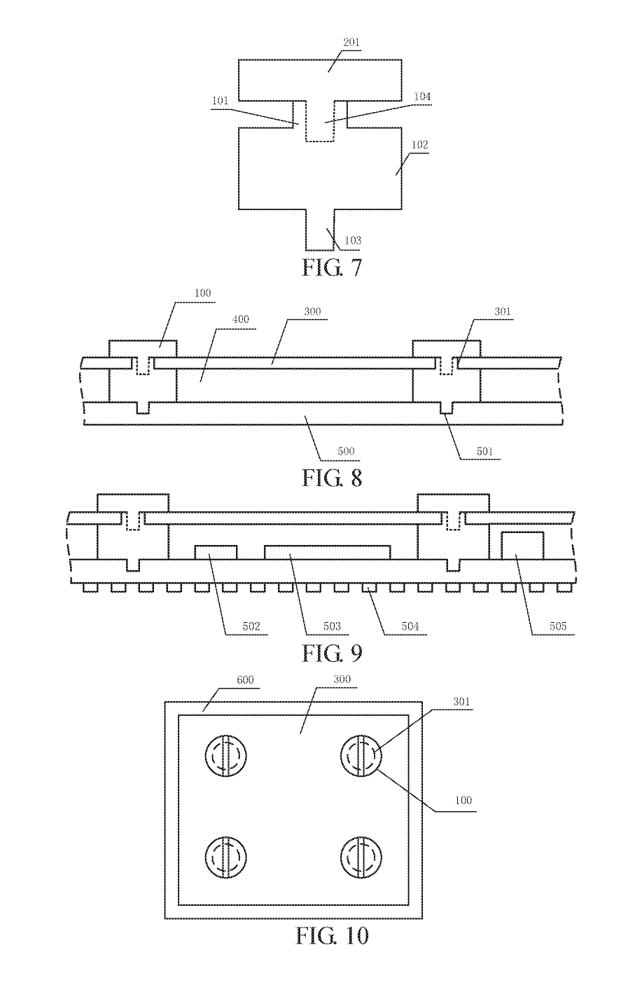

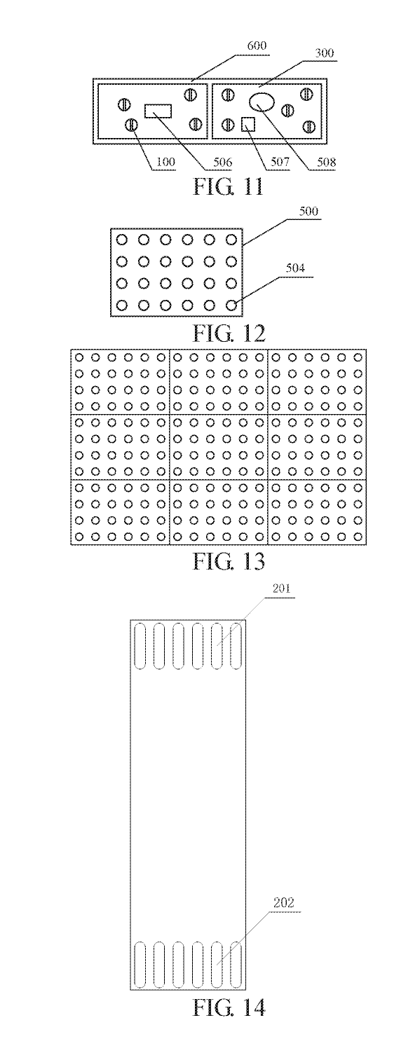

A backside of an LED display apparatus according to an embodiment is as shown in FIG. 10, and the LED display apparatus comprises a mounting frame 600 and a metal 20 plate 300. The metal plate 300 is provided with a plurality of fourth fixing places 301, and each of the plurality of fourth fixing places 301 is provided with a fixing part 100. A backside of an LED display apparatus according to another embodiment is as shown in FIG. 11. The metal plate 300 is provided with a plurality of through mounting places (i.e., vacant places) through which the relatively high components on the second side of 25 the mounting plate protrude, e.g., a first component 506, a second component 507, and a third component 508. As another example, a light-emitting side of an LED display apparatus according to an embodiment is as shown in FIG. 12, where a plurality of LED lamps 504 are regularly arrayed on the mounting plate 500. As another example, a light-emitting side of an LED display apparatus according to an embodiment is as shown in FIG. 13, where a plurality of LED displaying units are regularly disposed on the mounting plate 500, and a plurality of LED lamps are regularly arrayed on each of the LED displaying units.

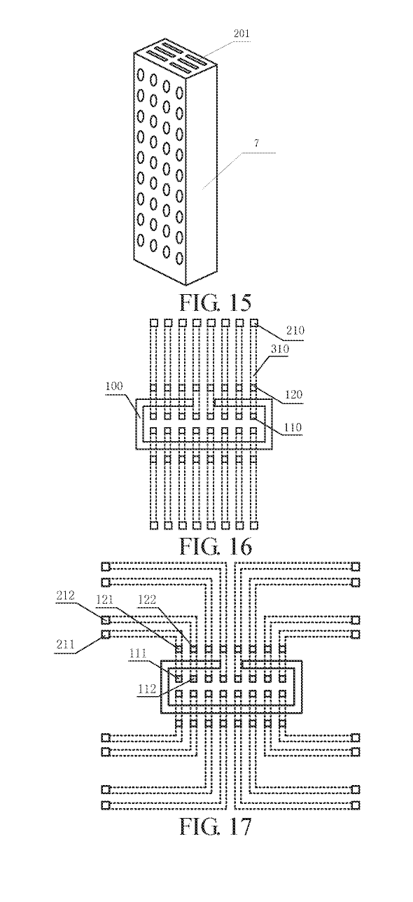

For example, a plurality of LED lamps 504 are disposed on the first side of the mounting plate, and a plurality of components are disposed on the second side of the mounting plate and are covered by the metal plates 300. The mounting places corresponding to the components are through places; for example, a certain component on the second side of the mounting plate protrudes from the metal plate. The insulative thermally conductive adhesive is a colloidal dispersion. As another example, the thermally conductive adhesive is a thermally conductive silica gel, a thermally conductive silicone grease or some other insulative adhesive, and is adapted to transfer heat between the mounting plate and the metal plate. To enhance the heat dissipation performance and increase the surface area for heat dissipation, the metal plate is preferably further provided with through holes. For example, the metal plate is provided with a plurality of through holes, and thus a better heat dissipation effect is achieved. The mounting plate is further provided with a plurality of metal pillars that are in close contact with the metal plate. For each of the components, a corresponding mounting place is provided on the metal plate during plate-making of the metal plate. For example, each resistor is provided with a resistor mounting place, and/or each 20 capacitor is provided with a capacitor mounting place, and/or each driving chip is provided with a driving chip mounting place, and/or each controlling chip is provided with a controlling chip mounting place, and so on. As another example, the mounting places on the metal plate are disposed according to the circuit diagram of the mounting plate. To avoid light interference between the LED lamps, grid portions are preferably disposed between the LED lamps. Preferably, metal grid portions are disposed between the LED lamps. Referring to FIG. 14 and FIG. 15, FIG. 14 is a schematic structural view of a preferred embodiment of a fixing support of an LED display apparatus according to the present disclosure; and FIG. 15 is a schematic structural view of another preferred embodiment of a fixing support of an LED display apparatus according to the present disclosure. The fixing support forms a rim Tat four sides thereof, and the rim may be formed by bending the four sides of the fixing support towards a same direction. The metal plate, the master control unit and the wireless communication module are disposed within the fixing support, the fixing support is provided with air outlets 201 and air inlets 202 so that a chimney structure is formed within the fixing support, and the heat generated by the mounting plate and the master control unit is dissipated from the fixing support by virtue of the convection effect. The air outlets 201 are disposed on a top surface or an upper portion of a side surface of the fixing support, and the air inlets 202 10 are disposed on a bottom surface or a lower portion of the side surface of the fixing support.

Further, embodiments of the present disclosure further comprise implementable fixing parts and LED display apparatuses formed by combining technical features of the aforesaid embodiments. The embodiments of the present disclosure use existing standard profiles to form cloud screen displaying products with good thermostability by using the least special processing techniques. While the objective of being ultra-thin and ultra-light is achieved, the thermostability and the overall space using efficiency can be demonstrated sufficiently and effectively. In a structural thermostability design: a supporting structural part directly transfers heat generated by power devices on an LED driving board from a metal structural plate that is in close contact with the heating devices to the rim that is connected with the metal structural plate, and becomes a heat dissipating part with a larger area. While the heat is transferred due to the aforesaid design, a hollow screen body is designed to achieve complete and effective air convection. The cold air enters from the lower end of the screenbody and rapidly exits from the upper end of the screen body through a chimney effect so that the temperature of the whole thermal balance is reduced.

At the same time, arrangement of signal lines and power supplying lines, connection between controlling panels as well as space placement need to be taken into consideration. Thereby, a reliable thermostability design can be accomplished in a producible manner and the objective of being ultra-thin can be achieved.

As shown in FIG. 16, FIG. 16 is a schematic view illustrating in header distribution of a power supplying structure of the LED display apparatus. The power supplying structure comprises a pin header connector 100 and a plurality of power connecting places 120. The pin header connector has a plurality of power supplying pins 110 to be connected to external power flexible cables. Each of the plurality of power supplying pins 110 is connected with one of the power connecting places 120 correspondingly so as to be connected with and supply power to the components of the LED display apparatus. For example, a power connecting place 120 is connected to a power supplying place 210 located at another position through a power line 310. Each of the power connecting places is configured to be connected with and supply power to at least one component of the LED display apparatus. In this way, concentrated and relatively thick power pins are eliminated, and power supply is transmitted, for example evenly or regionally, to a PCB board (the mounting plate) through the flexible cables to supply power to the components therein. In this way, the power supplying capacity of the power source is improved and the thickness of the LED display apparatus is favorably reduced. Preferably, power supplying places that are connected to the power connecting places correspondingly are disposed according to the functional regions on the PCB board, and the power supplying places are disposed regionally. As another example, the power supplying pin header is provided with a plurality of high-voltage pins and a plurality of low-voltage pins, and the two kinds of pins have different voltages. Of course, the pin header distribution may also vary differently, and this is within the understanding of those skilled in the art and thus will not be further described herein.

Embodiments of the present disclosure further provide a control system for an LED display apparatus. Referring to FIG. 17, FIG. 17 is a structural block diagram of a control system of an LED display apparatus according to a preferred embodiment of the present disclosure. The control system comprises an LED display apparatus 1000 described in the aforesaid embodiments and a cloud server 2000. The structural features of the LED display apparatus 1000 will not be further described herein.

The cloud server 2000 is connected to a wireless communication module 1001 of the LED display apparatus 1000 via a network and is configured to edit, store and analyze the information to be displayed by the LED display apparatus 1000 processing of the information to be displayed by the LED display apparatus 1000 is done on the cloud server 2000, so the LED display apparatus 1000 itself does not need a storing apparatus with a large capacity, and only the wireless communication module 1001 (e.g., a wifi interface) is retained to keep communication with the outside world (e.g., the cloud server 2000). Connection with the cloud server 2000 is achieved via a wireless network with wifi as a medium for information transfer so as to achieve tele-transmission of contents of the display screen and playing management of the LED display apparatus 1000.

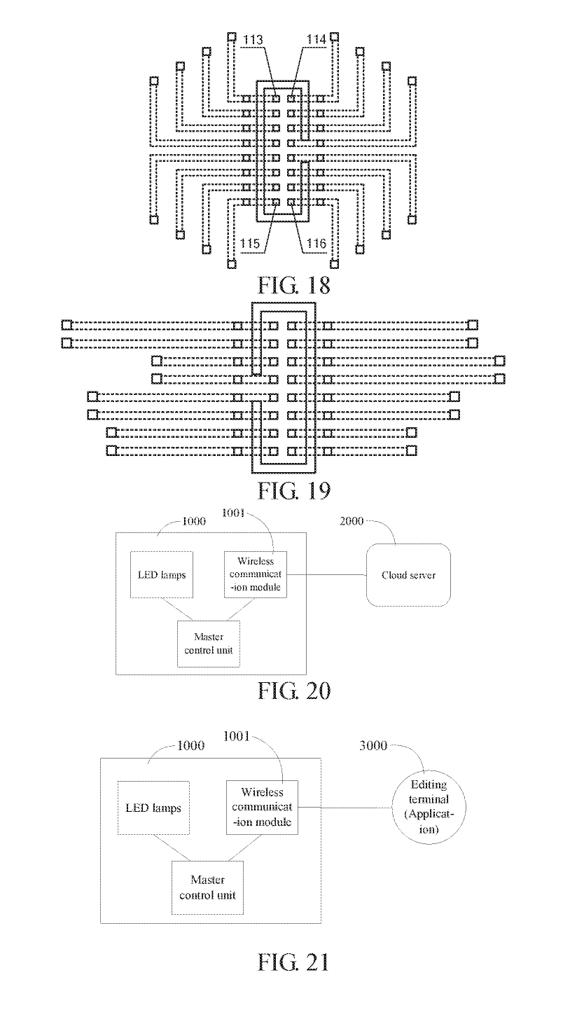

Referring to FIG. 18, FIG. 18 is a structural block diagram of another preferred embodiment of a control system of an LED display apparatus according to the present disclosure. The control system comprises the LED display apparatus 1000 and an editing terminal 3000. The editing terminal 3000 is connected with the LED display apparatus 1000 through wireless communication and is configured to edit information to be displayed by the LED display apparatus and send the information to be displayed that has been edited to the LED display apparatus 1000 for displaying. The editing terminal 3000 may be one of a mobile phone, a portable notebook computer or other wireless communication equipments.

Referring to FIG. 19, FIG. 19 is a structural block diagram of a further preferred embodiment of a control system of an LED display apparatus according to the present disclosure. The control system comprises the LED display apparatus 1000, the cloud sever 2000 and the editing terminal 3000. The editing terminal 3000 is connected with the cloud server 2000 and edits 25 information to be displayed by the LED display apparatus 1000 with the cloud server 2000 as a working platform, and the editing terminal 3000 stores the information to be displayed into the cloud server 2000 so that the LED display apparatus 1000 downloads the information to be displayed from the cloud server 2000 and displays the information to be displayed. The editing terminal 3000 has an application loaded therein, and is connected to the cloud server 2000 via the application so as to edit the information displayed on the LED display apparatus 1000.

The cloud server 2000 is further provided with an information exchange community for an owner of the LED display apparatus and an editor of the contents displayed by the LED display apparatus to exchange information. To make sure that the cloud screen can be used very effectively by those having no idea about the LED display screen, in other words, to make sure that use of the cloud screen is popularized in all industries and trades, the design of the cloud screen adopts a highly cloudized design concept. The concept comprises entirely cloudizing the work of the editor and cloudizing of the cloud screen market, and the latter has been achieved. Thus, users can fully and effectively understand all aspects of the cloud screen (e.g., the application effect, the shortcuts, and purchasing of a specific model of the cloud screen, etc.) through a cloud app without having the knowledge of the cloud screen. Meanwhile, a corresponding community may be formed for an owner of the cloud screen, an editor of the contents displayed by the cloud screen, and a third party that delivers the contents displayed by the cloud screen. The corresponding community enables them to have a sufficient understanding of the cloud screen while exchanging information and experiences with each other. Thus, they can fully exchange information about a display screen (even a production mode of the displayed contents) in the cloud community.

Preferably, the LED display apparatus 1000 further comprises an online upgrade module 1003, and the online upgrade module 1003 is connected to the master control unit 1002 and is configured to download the latest version of operation system from the cloud server 2000 and upgrade the system via the wireless communication module 1001. LED 25 lamps 1004 are the LED lamps mounted on the mounting plate of the LED display apparatus in the aforesaid embodiments, and the master control unit 1002 controls the lighting of the LED lamps 1004.

Preferably, the master control unit 1002 has an operation system embedded therein, the displayed contents controlled and managed by the whole cloud screen are not displayed locally but are wirelessly displayed on a remote terminal completely through the wireless communication module 1001 (e.g., wifi). Control of the local embedded computer is implemented all by the remote terminal through the wireless communication module 1001, including adjustment of parameters, updating of data, transmission of instructions for management and control, and timely feedback of states, and all these are not displayed locally but displayed fully on a remote display screen through data transmission of wifi. In this embodiment, the cloud screen control system adopts a close combination of an embedded system and a conventional display screen system. In this way, equipments required by a traditional computer in managing and controlling an LED display screen are reduced to the greatest extent; that is, devices and equipments required by a standard computer in controlling a display screen (i.e., in the prior art) are omitted, e.g., peripherals such as a keyboard, a mouse, or a display. More preferably, all auxiliary devices (e.g., a hard disk or other storing devices) except for the main board may be electronized or omitted. Only the wireless communication module 1001 (e.g., a wifi interface) is kept to communicate with the outside world. Then, a unique cloud channel is implemented by using wireless communication as the sole information transfer medium so as to wirelessly monitor transmission of contents of the display screen and the playing management.

The control system according to the embodiments of the present disclosure can achieve effective communication between users of the LED display apparatuses as well as between a user and a service provider, and the full working process of the LED display apparatus is edited and controlled by the cloud server and cloud netware, so the convenience in use of the LED display apparatus is remarkably improved and the application scope of the LED display apparatus is widened.

Referring to FIG. 20, FIG. 20 is a schematic flow chart diagram of a preferred embodiment of a communication method for an LED display apparatus according to the present disclosure. The communication method comprises (but is not limited to) the following steps:

Step S100: transmitting an information displaying desire to a cloud service platform by an information displaying demand side according to a displaying demand of the LED display apparatus. For example, the information displaying demand side may be an owner of the LED display apparatus. The owner of the LED display apparatus wants to play contents that he/she needs to display or other contents, but he/she is not very familiar with the editing method of the contents that need to be displayed, so he/she needs to send out a desire or an invitation to the cloud service platform to express that he/she needs assistance of the cloud service platform to edit the contents that need to be displayed by the LED display apparatus.

Of course, the information displaying demand side may also be a third party other than the owner of the LED display apparatus. The third party sends out a desire or an invitation to the cloud service platform. The third party may establish communication with the cloud service platform through wifi or the wired Internet, etc.

Step S110: transmitting the information displaying desire to a displayed information editing side by the cloud service platform.

In the step S110, the cloud service platform may have its own information editing team to edit the displayed contents proposed by the owner of the LED display apparatus, or it may cooperate with other individual displayed information editing sides.

Step S120: editing contents of the displayed information by the displayed information editing side on the cloud service platform according to the demand of the information displaying demand side, and storing the displayed information contents that have been edited into the cloud service platform.

The displayed information editing side of this embodiment includes displayed contents designers, displayed contents design teams or part-time displayed contents designing and organizing persons and so on.

Step S130: simulating the displayed information contents that have been edited on the LED display apparatus.

For sufficient and effective interaction between design service provided by a cloud screen displayed information designer and a cloud screen owner on a cloud screen service trading platform, excellent displayed information effect of the designer needs to be fully and effectively browsed, evaluated and compared by the cloud screen owner before the trading is finally concluded, thereby forming a trading platform market for the service. That is, the cloud screen owner can choose desired or appropriate displayed contents according to the position of his/her cloud screen and his/her own preferences and simulate the displayed contents on his/her cloud screen, and then decide whether to adopt the displayed contents officially or displaying depending on the simulation result. In a preferred mode, the resulting simulation file of the displayed contents cannot be directly transmitted to the cloud screen for displaying by the cloud screen owner; and otherwise, fairness of the trading will not be ensured and large scale trading will become impossible. Thus, the following measures are adopted: the cloud screen owner can see the same playing effect of the displayed contents, but the contents cannot be played or achieved on the cloud screen, and this is the key point of the simulation market structure. In this step, the cloud screen trading platform not only can simulate the displayed contents for the cloud screen owner, but also can simulate the displayed contents for and exchange the displayed contents with a third party other than the owner of the cloud screen (e.g., a third party with an information displaying demand). If the third party is satisfied with the displayed contents, the next step is executed.

Step S140: transmitting the displayed information that has been edited to the LED display apparatus by the cloud service platform for displaying. Before this step, the approval of the information displaying demand side or the third party with the information displaying demand is required before transmitting the displayed information that has been edited to the LED display apparatus for displaying.

Referring to FIG. 21, FIG. 21 is a structural block diagram of a preferred embodiment of a communication system according to the present disclosure. The communication system comprises an LED display apparatus 1901, a cloud service platform 1902, an information displaying demand side 1903 and a displayed information editing side 1904. Specifically, the cloud service platform 1902 is communicatively connected with the LED display apparatus 1901, the information displaying demand side 1903 transmits an information displaying desire to the cloud service platform 1902 according to a displaying demand of the LED display apparatus 1901, and the cloud service platform 1902 transmits the information displaying desire to the displayed information editing side 1904. During this process, there may be many displayed information editing sides 1904 for option, and meanwhile a screening mechanism for the displayed information editing sides 1904 is provided to evaluate and classify the displayed information editing sides 1904 so as to finally pick out an optimal displayed information editing side 1904 and transmit the information displaying demand to the optimal displayed information editing side 1904. Additionally, a bid mechanism may also be utilized to choose the displayed information editing side 1904, and information such as cost performance of different displayed information editing sides 1904 is judged according to the offer prices of their designed works so as to choose the optimal displayed information editing side 1904. Of course, the way to choose the displayed information editing side 1904 is not limited to the aforesaid examples.

The displayed information editing side 1904 edits contents of the displayed information on the cloud service platform 1902 according to the demand of the information displaying demand side 1903 and stores the displayed information contents that have been edited into the cloud service platform 1902, and the cloud service platform 1902 transmits the displayed information that has been edited to the LED display apparatus for displaying. The cloud service platform 1902 comprises a simulation module (not shown) configured to simulate the displayed information contents that have been edited on the LED display apparatus 1901 before the displayed information contents that has been edited are transmitted to the LED display apparatus 1901 for displaying.

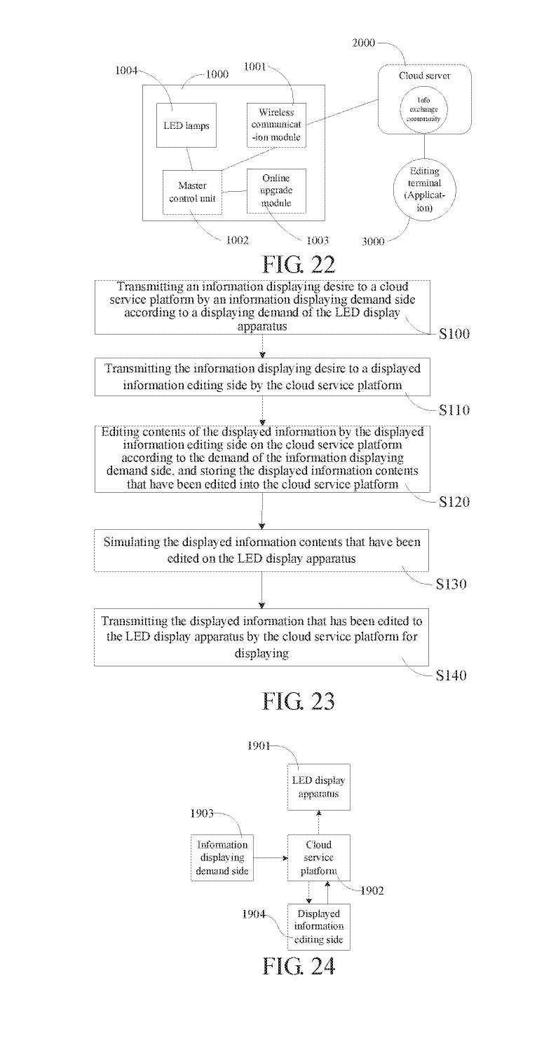

Referring to FIG. 22, FIG. 22 is a structural block diagram of another preferred embodiment of a communication system according to the present disclosure. This embodiment differs from the previous embodiment in that the information displaying demand side is an owner of the LED display apparatus. Technical features of other parts of the information interaction are the same as those of the previous embodiment, and thus will not be further described herein. Referring to FIG. 23, FIG. 23 is a schematic flowchart diagram of a preferred embodiment of a trading method based on an LED display apparatus according to the present disclosure. The trading method comprises (but is not limited to) the following steps:

Step S200: purchasing an LED display apparatus and obtaining the ownership of the LED display apparatus by a user.

The user can choose a business mode that is the same as or similar to his/her market and dispose cloud screens of different sizes and different effects at different desired positions so that the user can simulate and watch the effect of the displayed contents and make a decision on purchasing the cloud screens according to the effect. Likewise, a reference store environment design may provide corresponding references to the owner of the cloud screen in designing of his/her store and purchasing of the cloud screen.

Step S210: transmitting a desire to display information on the LED display apparatus to a cloud service platform by a demand side displaying information on the LED display apparatus. In the step S210, the demand side that desires to display information on the LED display apparatus may be an owner of the cloud screen or other displayed contents providers. The owner of the cloud screen or the displayed contents provider may be unfamiliar with the editing method of graphic displayed contents, so he may transmit an information displaying desire to the cloud service platform or he may call for a bid in the cloud service platform and send out invitations for designing displayed contents to all the editors of the contents displayed by the cloud screen. The cloud service platform may have its own information editing team to edit the displayed contents proposed by the owner of the LED display apparatus, or it may cooperate with other individual displayed information editing sides. Step S220: finding a displayed information editor by the cloud service platform according to the information displaying desire, wherein the displayed information editor edits the displayed information required by the user of the LED display apparatus.

In the step S220, the displayed information editor can edit the displayed information required by the user of the LED display apparatus on the cloud service platform, so the structure of the editing terminal used by the editor can be simplified. In this way, the editing terminal used by the editor can only comprise input equipments (e.g., a key board, a display, etc) and does not need to comprise any storing equipment, and this also makes the saving of the contents that have been edited convenient.

The vivid displaying effect not only allows the hardware products of the cloud screen itself to be exhibited and popularized effectively, but also makes the editing service of the contents displayed by the cloud screen a trading product of a great market value. Special effects of different styles in cloud screen editing that are displayed by individual designers (i.e., displayed information editors) as well as extraordinary design thoughts of the editors can all become the most valuable trading products in this trading platform.

The displayed contents editor can rapidly and effectively form an impressive effect for the contents displayed by the cloud screen according to the demands of the cloud screen owner and the characteristics of the displayed content edition. Then the displayed contents editor communicates with the owner on the cloud server, and when the owner approves the edited product of the editor, the owner can download the product of the editor to his/her own cloud screen for displaying by purchasing the product or forming a partnership so as to achieve the effect of the displayed contents.

The cloud screen owner decides to purchase the design service of a certain editor after browsing and evaluating the effects of the displayed contents offered by different displayed contents editors. After the design service is paid online and the trading is finished, the cloud screen owner can directly download an executable file package of the displayed contents design and upload it to the cloud screen to achieve the desired effect of the displayed contents. Step S230: simulating the displayed information contents that have been edited on the LED display apparatus. To effectively sell the design service of the cloud screen displayed contents designer on a cloud screen service trading platform, the excellent and vivid displayed contents effect of the designer needs to be fully and effectively browsed, evaluated and compared by the cloud screen owner before the trading is finally concluded, thereby forming a trading platform market for the service. However, the resulting simulation file of the displayed contents preferably cannot be directly transmitted to the cloud screen for displaying by the owner of the cloud screen; and otherwise, fairness of the trading will not be ensured and large scale trading will become impossible. Thus, an effective method is as follows: the cloud service platform only provides the cloud screen owner with a playing effect of the same displayed contents, but the contents cannot be modified or played on the cloud screen, and this is the key point of the simulation market structure. However, in other embodiments of particular market conditions, the cloud screen owner may also directly obtain the simulated file for simulation. This will not be enumerated herein.

Step S240: transmitting, by the cloud service platform, the displayed information that has been edited by the displayed information editor to the LED display apparatus for displaying. In this step, the operator of the cloud service platform can control displaying characteristic parameters (e.g., the displayed time, the brightness and the cycle period) of the cloud screen according to practical situations.

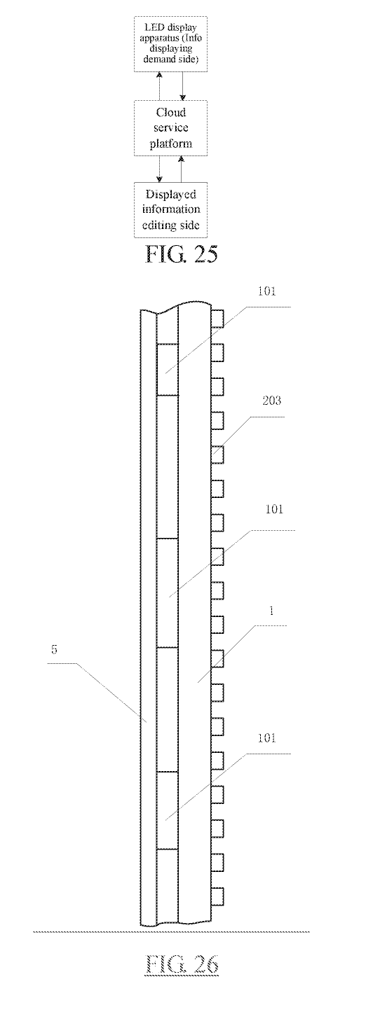

Referring to FIG. 24 and FIG. 25 together, FIG. 24 is an information flowchart diagram between trading parties of an embodiment of the trading method in the embodiment of FIG. 23, and FIG. 25 is an information flowchart diagram between trading 25 parties of another embodiment of the trading method in the embodiment of FIG. 23.

As shown in FIG. 24, the owner of the cloud screen transmits an information displaying desire to the cloud service platform according to the contents that need to be displayed, the cloud service platform finds an optimal displayed information editor according to the information displaying desire, and the displayed information editor edits the displayed information required by the user of the LED display apparatus and transmits the displayed information to the LED display apparatus for displaying after the simulation.

Moreover, as shown in FIG. 25, the displayed contents provider can also directly transmit an information displaying desire to the cloud service platform according to the contents that need to be displayed, the cloud service platform finds an optimal displayed information editor according to the information displaying desire, and the displayed information editor edits the displayed information required by the user of the LED display apparatus and transmits the displayed information to the LED display apparatus 10 for displaying after the simulation. After the whole process is finished, payment is made to the cloud screen platform (or the cloud service platform) by the owner of the cloud screen. The platform takes a certain proportion (e.g., 30%) of the payment and directly hands the remaining payment (e.g., 70%) over to the editor of the contents displayed by the cloud screen. Thereby, a “triple-win” effect is achieved: that is, the owner of the cloud screen obtains colorful and impressive displayed contents, the editor of the contents displayed by the cloud screen can edit the displayed contents of owners almost all over the world at a tiny cost and achieve a large-scale visualization market without leaving home, and the cloud screen platform also receives a certain proportion (e.g., 30%) of the payment. Thus, the “triple-win” situation can be fully realized.

Moreover, the “triple-win” mode can be achieved by a third-party provider of the displayed contents in a same way. That is, the third-party provider of the displayed contents does not have to own the cloud screen directly, and he can sign a bid contract about the displayed contents with the owner of the cloud screen through the cloud screen market, so the owner of the cloud screen not only can play his/her own displayed contents but also can solicit business of playing displayed contents from a third party on the cloud screen through the cloud screen market. In this way, the owner of the cloud screen not only can play his/her own displayed contents but also can play the displayed contents of a third party to earn more money and gain more benefits. All the displayed contents providers can make contact with users with immediate consumption demand sat the earliest time and deliver their displayed contents in a targeted way, and this is exactly the most valuable representation of the displayed contents. The marketing benefits generated by direct contact with the direct payer are incomparable to any other current types of displayed contents. The cloud screen market can obtain a certain proportion (e.g., 30%) of benefits by bringing the providers and the owners into contact with each other. Thus, another “triple-win” mode is created.

Resources of a displayed contents provider, a cloud screen owner and a designer are effectively integrated together through the cloud service platform by the trading method based on an LED display apparatus according to the embodiments of the present disclosure, so all the aforesaid parties can exchange information through the cloud service platform and two “triple-win” business modes are created between the cloud screen owner, the cloud service platform and the designer as well as between the cloud screen owner, the cloud service platform and the displayed contents provider respectively. This has a very high market operation value. Hereinafter, the overall layout of the embodiments of the present disclosure will be further introduced from the mechanical structure of the cloud screen to the business operation mode of the cloud screen trading market.

It may be divided into five levels, i.e., from bottom to top the mechanical structure of the cloud screen, the control system of the cloud screen, the operational software of the cloud screen, the cloud net ware, and the business operation mode of the cloud screen trading market. Specifically, first in the aspect of the mechanical structure of the cloud screen: the key point in the designing thereof is to use existing standard profiles to form cloud screen displaying products of good thermostability with the least special processing techniques. While the objective of being ultra-thin and ultra-light is achieved, the thermostability and overall space using efficiency are demonstrated sufficiently and effectively. Please refer to descriptions of the structures of FIG. 3 to FIG. 13 in the aforesaid embodiments. A highlight in the structural thermostability design is as follows: a supporting structural part (i.e., the fixing part in the aforesaid embodiments) directly transfers heat generated by power devices on an LED driving board (i.e., the master control unit on the mounting plate) from a metal structural plate (i.e., the metal plate) that is in close contact with the heating devices to the rim that is connected with the metal structural plate and makes the metal structural plate a heat dissipating part with a larger area. Furthermore, please refer to FIG. 14 and FIG. 15 for descriptions of the structure of the heat dissipating part of the fixing part. While the heat is transferred due to the aforesaid design, a hollow screen body is designed to achieve complete and effective air convection. The cold air enters from the lower end of the screen body and rapidly exits from the upper end of the screen body through a chimney effect so that the temperature of the whole thermal system is reduced. At the same time, arrangement of signal lines and power supplying lines, connection between controlling panels as well as space placement all need to be taken into consideration. Thereby, a reliable thermostability design can be accomplished in a producible manner while the objective of being ultra-thin is achieved.

In the aspect of the control system of the cloud screen: a completely new way that closely combines an embedded system with a conventional display screen system is adopted. Here, equipments required by a traditional computer in managing and controlling an LED display screen are reduced to the greatest extent; that is, devices and equipments required by a standard computer in controlling a display screen are omitted, e.g., peripherals such as a keyboard, a mouse, or a display. Moreover, all auxiliary devices (e.g., a hard disk or other storing devices) except for the main board are electronized or omitted. Only a wifi interface is kept to communicate with the outside world. Thus, a unique cloud channel is implemented with wifi as a sole information transfer medium to wirelessly monitor transmission of contents of the display screen and the playing management. Please refer to the embodiments of the control system of the LED display apparatus in FIG. 17 and FIG. 18 for details.

In the aspect of the operation software of the cloud screen: the operation system of the cloud screen is rooted in the whole embedded system of the cloud screen, and the system features wireless communication. In other words, the displayed contents controlled and managed by the whole cloud screen are not displayed locally but are wirelessly displayed on a remote terminal completely through wifi. Control of the local embedded computer is implemented all by the remote terminal through the wireless communication module 1001, including adjustment of parameters, updating of data, transmission of instructions for management and control, and timely feedback of states, and all these are not displayed locally but displayed fully on a remote display screen through data transmission of wifi. This is a completely new management and control mode. Please refer to relevant descriptions for the embodiments of the cloud screen control method in FIG. 20 to FIG. 21 for details.

In the aspect of cloud netware: to make sure that the cloud screen can be used very effectively by those having no idea about the LED display screen, in other words, to make sure that the cloud screen gets popularized in all industries and trades, the design of the cloud screen adopts a highly cloudized design concept. The concept comprises entirely cloudizing the work of the editor and the cloud screen market, and the latter has been achieved. Thus, users can sufficiently and effectively understand all aspects of the cloud screen (e.g., the application effect, the shortcut, and purchasing of a specific model of the cloud screen, etc.) through a cloud app without having the knowledge of the cloud screen. Meanwhile, a corresponding community may be formed for an owner of the cloud screen, an editor of the contents displayed by the cloud screen, and a party that delivers the contents displayed by the cloud screen. The corresponding community enables them to have a sufficient understanding of the cloud screen while exchanging information and experiences with each other, and thus they can fully exchange information about a display screen (even a manufacturing mode of the displayed contents) in the cloud community. This is an unprecedented platform mode for the displayed contents.

In the aspect of the business operation mode of the cloud screen trading market: the key to the success of the cloud screen is the success of the business mode. Specifically, the benefits of all the parties, e.g., the displayed contents provider, the owner of the cloud screen and the editor of the contents displayed by the cloud screen or the like, are linked together by the cloud screening a way that finally benefits the users.

For example, the owner of the cloud screen is unfamiliar with the editing method of graphic displayed contents, so he can call for a bid in the cloud service platform and send out invitations for designing displayed contents to all the editors of the contents displayed by the cloud screen. The displayed contents editor (the displayed information editor in the aforesaid embodiments) rapidly and effectively forms an impressive effect for the contents displayed by the cloud screen according to the demands of the cloud screen owner and the characteristics of the displayed content edition. Then the displayed contents editor communicates with the owner on the cloud server, and when the owner approves the edited product of the editor, the owner can download the product of the editor to his/her own cloud screen only by purchasing the product so as to achieve the effect of the displayed contents. Payment is made to the cloud screen platform (or the cloud service platform) by the owner of the cloud screen. The platform takes a certain proportion (e.g., 30%) of the payment and directly hands the remaining payment (e.g., 15 70%) over to the editor of the contents displayed by the cloud screen. Thereby, a “triple-win” effect is achieved: that is, the owner of the cloud screen obtains colorful and impressive displayed contents, the editor of the contents displayed by the cloud screen can edit the displayed contents of owners almost all over the world at a tiny cost and achieve a scale marketing of the visualized market without leaving home, and the cloud screen platform also receives a certain proportion (e.g., 30%) of payment. Thus, the “triple-win” situation can be fully created.

While the displayed contents of the industry and the products of the cloud screen owner are getting played, it is totally beneficial for the owner of the cloud screen to gain product and service support from related industries or associated industries, for example to gain the support of liquor and beverage industries for the catering industry. Thus, the owner of the cloud screen can obtain the support of the displayed contents of desired and related industries on are marketing platform of the displayed contents, and meanwhile the owners of displayed contents of the related industries also look forward to cooperating with the displayed contents of specific enterprises. This creates a multi-win consumption market of displayed contents.

For example, the “triple-win” mode can be created by a third-party provider of the displayed contents in a same way. That is, the third-party provider of the displayed contents does not have to own the cloud screen directly, and he can sign a bid contract about the displayed contents with the owner of the cloud screen through the cloud screen market. Thus, the owner of the cloud screen not only can play his own displayed contents but also can solicit business of playing displayed contents from a third party on the cloud screen through the cloud screen market. In this way, the owner of the cloud screen not only can play his/her own displayed contents but also can play the displayed contents of a third party to earn more money and gain more benefits. All the displayed contents providers can make contact with users with immediate consumption demands at the earliest time and deliver their displayed contents in a targeted way, and this is exactly the most valuable representation of the displayed contents. The marketing benefits generated by direct contact with the direct payer are incomparable to any other current types of displayed contents. The cloud screen market can obtain a certain proportion (e.g., 30%) of benefits by bringing the providers and the owners into contact with each other. Thus, another “triple-win” mode is created. The aforesaid embodiments completely describe the business industrial chain based on a cloud screen in five levels from the mechanical structure of the cloud screen to the business operation mode of the cloud screen trading market, and this industrial chain has great business practical values.

What described above are only the embodiments of the present disclosure, but are not intended to limit the scope of the present disclosure. Any equivalent structures or equivalent process flow modifications that are made according to the specification and the attached drawings of the present disclosure, or any direct or indirect applications of the present disclosure in other related technical fields shall all be covered within the scope of the present disclosure.

What is claimed is:

1. A control system communicatively coupled with a light emitting diode (LED) display apparatus for controlling the LED display apparatus, the control system comprising:
an editing terminal communicatively coupled with the LED display apparatus;
a master control unit; and
a wireless communication module communicatively coupled with the master control unit and the editing terminal,
wherein the master control unit is configured to process a control signal of the LED display apparatus and drive LED lamps of the LED display apparatus, and
wherein the editing terminal is configured to edit information to be displayed by the LED display apparatus and send the edited information to the LED display apparatus for displaying.

2. The control system of claim 1, further comprising a cloud server,
wherein the cloud server is connected to the wireless communication module and the editing terminal via a network,
wherein the editing terminal is configured to store the information to be displayed on the cloud server, and
wherein the cloud server is configured to store and process the information to be displayed, and transmit the processed information to the LED display apparatus for display.

3. The control system of claim 2, wherein the editing terminal is one of a mobile phone, a portable notebook computer, and a desktop computer.

4. The control system of claim 2, wherein an application is executed on the editing terminal that enables (1) the editing terminal to be communicatively coupled with the cloud server and (2) a user of the editing terminal to edit the information displayed on the LED display apparatus.

5. The control system of claim 2, wherein the cloud server is configured to enable an owner of the LED display apparatus to establish an information exchange community and wherein the cloud server further comprises an editor for editing the content being displayed by the LED display apparatus to exchange information.

6. The control system of claim 2, further comprises an online upgrade module communicatively coupled with the master control unit and configured to download the latest version of operation system from the cloud server and upgrade the operation system via the wireless communication module.

7. The control system of claim 1, wherein the LED display apparatus further comprises a metal plate and a mounting plate, a plurality of LED lamps are arrayed on one side of the mounting plate and the master control unit is disposed on the other side of the mounting plate, the metal plate is connected with the side of the mounting plate where the master control unit is disposed so as to dissipate heat from the mounting plate, the metal plate is spaced apart from the mounting plate via a fixing part, and the fixing part comprises a body, a first fixing portion and a convex portion, and wherein the body has two opposite sides, the first fixing portion protrudes from the first side and is connected to the mounting plate, the convex portion protrudes from the second side and is connected to the metal plate, and an insulative thermally conductive adhesive is disposed between the metal plate and the mounting plate.

8. A communication method based on an LED display apparatus, comprising the following steps of:
receiving content information from an information displaying demand side of a cloud service platform;
transmitting the content information to a displayed information editing side, wherein the displayed information editing side is configured to edit the content information;
receiving and storing the edited content information; and
transmitting the edited content information to the LED display apparatus for displaying.

9. A communication method based on an LED display apparatus, comprising the following steps of:
transmitting, by an information displaying demand side, content information to a cloud service platform according to a displaying demand of the LED display apparatus;
transmitting, by the cloud service platform, the content information to a displayed information editing side;
editing, by the displayed information editing side on the cloud service platform, the content information according to the demand of the information displaying demand side, and storing the edited content information on the cloud service platform; and
transmitting, by the cloud service platform, the edited content information to the LED display apparatus for displaying.

10. The communication method of claim 9, further comprising the following step:
before transmitting the edited content information to the LED display apparatus, simulating a display of the edited content information.

11. The communication method of claim 9, wherein the information displaying demand side is one of an owner of the LED display apparatus and a third party other than the owner of the LED display apparatus.

12. A communication system for an LED display apparatus, comprising:
a cloud service platform communicatively coupled with the LED display apparatus;
an information displaying demand side configured to transmit content information to the cloud service platform according to a displaying demand of the LED display apparatus; and
a displayed information editing side,
wherein the cloud service platform is configured to transmit the content information displaying to the displayed information editing side,
wherein the displayed information editing side is configured to edit the content information according to the demand of the information displaying demand side and store the edited content information on the cloud service platform, and
wherein the cloud service platform is configured to transmit the displayed information that has been edited to the LED display apparatus for displaying.

13. The communication system of claim 12, wherein the cloud service platform comprises a simulation module configured to simulate a display of the edited content information before the displayed edited content information is transmitted to the LED display apparatus for displaying.

14. The communication system of claim 12, wherein the information displaying demand side is one of an owner of the LED display apparatus and a third party other than the owner of the LED display apparatus.

15. A trading method based on an LED display apparatus, comprising the following steps of:
purchasing an LED display apparatus and obtaining the ownership of the LED display apparatus by a user;
transmitting content information on the LED display apparatus to a cloud service platform by a demand side that desires to display the content information on the LED display apparatus;
finding a displayed information editor by the cloud service platform according to the information displaying desire, wherein the displayed information editor edits the content information required by the user of the LED display apparatus; and
transmitting, by the cloud service platform, the edited content information to the LED display apparatus for displaying.

16. The trading method of claim 15, further comprising the following step before the step of transmitting, by the cloud service platform, the edited content information to the LED display apparatus for displaying: simulating a display of the edited content information.

17. The trading method of claim 15, wherein the owner of the LED display apparatus can play his/her own displayed contents or contents required by a third party on his/her LED display apparatus.
